(19) United States
(12) Patent Application Publication
(10) Pub. No.: US 2022/0042364 A1
(43) Pub. Date: Feb. 10, 2022

(54) DEVICE FOR MOVING A LEAF DOOR

(71) Applicant: Daniele AMERIO, Conzano (AL) (IT)

(72) Inventor: Daniele AMERIO, Conzano (AL) (IT)

(21) Appl. No.: 17/415,391

(22) PCT Filed: Dec. 17, 2019
(86) PCT No.: PCT/IB2019/060928

§ 371 Date: Jun. 17, 2021

(30) Foreign Application Priority Data
Dec. 18, 2018 (IT) 102018000020149

(51) Int. Cl. E05F 15/627; E05F 15/63

(52) U.S. Cl. CPC E05F 15/627; E05F 15/63; E05Y 2201/434; E05Y 2900/132; E05Y 2201/702; E05Y 2201/656; E05Y 2201/716; E05Y 2201/624

(57) ABSTRACT

A device for moving a leaf door, including an electric motor (30), a reduction gear box (40) and a crown wheel-pinion transmission system (50) is provided. The electric motor (30) is kinematically connected to the reduction gear box (40), which in turn is kinematically connected to the crown wheel-pinion transmission system (50). The reduction gear box (40) is reversible.

### TECHNICAL FIELD

The present invention relates to a moving device for opening and closing a leaf door, and more particularly to a moving device of the automatic type.

### BACKGROUND ART

Moving devices are known which are used for the automatic opening and closing of leaf doors, in particular in supermarkets, offices, restaurants, etc.

Such moving devices usually involve the use of an electric motor kinematically connected, through motion-transmitting means, to a rigid or articulated arm, which in turn is connected to a leaf of the leaf door for opening or closing the same.

Generally, motion-transmitting means introduce a series of reduction stages between the electric motor and the articulated arm. This reduction is necessary because the rotational speed (angular speed) of the motor is usually too high to be applied directly to the articulated arm and would not allow opening and closing of the door at a sufficiently low speed.

In order to reduce the number of components making up the moving devices of leaf doors, there exists the need to reduce the number of reduction stages introduced by said motion-transmitting means.

Document AU2011101534 (A4) discloses, for example, a moving device mainly for industrial application, which moving device comprises a motor and motion-transmitting means including a reduction gear box having a worm screw and a helical toothed wheel and a crown wheel-pinion transmission system with chain. The reduction gear box, directly connected to the motor, introduces a reduction ratio of 50:1, whereas the crown wheel-pinion transmission system, having nine teeth and a crown with thirty teeth, introduces a reduction ratio of 3.3:1.

Although the above-mentioned moving device has a reduced number of reduction stages, it has the problem that the reduction gear box is not reversible, not allowing the door to be opened and closed manually. This is due to the excessive reduction ratio introduced by the reduction gear box, which results in an excessively reduced helix angle of the worm screw, which, as is known, does not allow motion to be transmitted from the helical wheel to the worm screw.

It is an object of the present invention to overcome the problems and limitations of prior art by providing a moving device for leaf doors that, in addition to providing a sufficiently high reduction ratio and having a reduced number of components of the motion-transmitting means, is also reversible.

A further object of the present invention is to provide a moving device having reduced space requirements. A further object of the present invention is to provide a reliable moving device that ensures a high number of open-close cycles.

These and other objects are achieved by the device for moving a leaf door as claimed in the appended claims.

### SUMMARY OF THE INVENTION

The device for moving a leaf door according to the present invention comprises an electric motor, a reduction gear box (reduction gear) and a crown wheel-pinion transmission system.

The electric motor is kinematically connected to the reduction gear box, which in turn is kinematically connected to the crown wheel-pinion transmission system, configured to move an articulated arm that is connected in a known manner to a leaf of the leaf door for opening or closing the same.

The reduction gear box is reversible and this advantageously allows to manually open and close the door leaf easily, without encountering too much resistance, in the event that the electric motor is not energized and thus the door leaf is not opened and closed automatically.

Preferably, the reduction gear box is a worm screw gear box, thus comprising a worm screw and a helical toothed wheel. The worm screw is kinematically connected in a rotationally fixed manner to a shaft of the electric motor, whereas the helical toothed wheel is coupled to the worm screw and is kinematically connected in a rotationally fixed manner to an output shaft of the reduction gear box. The reduction gear box has a reduction ratio R′, defined as the ratio between the rotational speed ω1 of the motor shaft and the rotational speed ω2 of the output shaft of the reduction gear box, between 10:1 and 20:1. This reduction ratio R′ allows to meet the requirement of having a sufficiently large reduction and to obtain, at the same time, a reduction gear box of worm-screw type that is reversible.

The crown wheel-pinion transmission system comprises a toothed pinion and a toothed crown wheel that are kinematically connected to each other by means of a roller chain. The pinion is kinematically connected in a rotationally fixed manner to the output shaft of the reduction gear box, whereas the toothed crown wheel is kinematically connected in a rotationally fixed manner to an output shaft of the moving device. The crown wheel-pinion transmission system has a reduction ratio R″, defined as the ratio between the rotational speed ω2 of the output shaft of the reduction gear box and the rotational speed ω3 of the output shaft of the moving device, between 3:1 and 8.75:1, more preferably between 4:1 e 6:1.

The chain of the crown wheel-pinion transmission system has a pitch between 6 mm and 8 mm. The use of a chain with a pitch within the range mentioned above makes it possible to meet the requirement of having a sufficiently strong chain, while allowing use of a pinion of sufficiently small size. This makes it possible to maintain a sufficiently high reduction ratio R″ while keeping the size of the crown wheel small, so as to limit the overall dimensions of the moving device, particularly in the direction orthogonal to the output shaft of the moving device.

According to the present invention, the reduction ratio R′ of the reduction gear box and the reduction ratio R″ of the crown wheel-pinion transmission system are chosen so as to obtain an overall reduction ratio R of the moving device between 60:1 e175:1. According to the present invention, the chain of the crown wheel-pinion transmission system preferably comprises O-rings located about chain pins and arranged to seal lubricant in the regions between pins and bushings of the chain. This ensures a longer life of the chain and therefore a greater number of open-close cycles of the moving device.

According to the present invention, the chain of the crown wheel-pinion transmission system is optionally a double chain.

According to a further embodiment of the invention, the moving device comprises a crown wheel-pinion transmission system in which the toothed pinion and the toothed crown wheel are directly coupled to each other. Similarly to what has been described in connection with the previous embodiment, the pinion is kinematically connected in a rotationally fixed manner to the output shaft of the reduction gear box and the toothed crown wheel is kinematically connected in a rotationally fixed manner to the output shaft of the moving device. The crown wheel-pinion transmission system has a reduction radio between 3:1 and 10:1. The reduction ratio of the reduction gear box and the reduction ratio of the crown wheel-pinion transmission system are chosen so as to obtain an overall reduction ratio of the moving device between 60:1 e 200:1.

### BRIEF DESCRIPTION OF THE DRAWINGS

These and other features and advantages of the present invention will be more evident from the following description of preferred embodiments given by way of non-limiting examples with reference to the annexed drawings, in which elements designated by same or similar reference numerals indicate elements that have same or similar functionality and construction, and in which:

FIG. 1 is a perspective view of a device for moving a leaf door according to the present invention;

FIG. 2 is a perspective view of a transmission assembly included in the moving device of FIG. 1;

FIG. 3 is a bottom view of the transmission assembly of FIG. 2;

FIG. 4 is a bottom view of the transmission assembly of FIG. 2 and of a frame plate of the moving device of FIG. 1.

### DESCRIPTION OF SOME PREFERRED EMBODIMENTS OF THE INVENTION

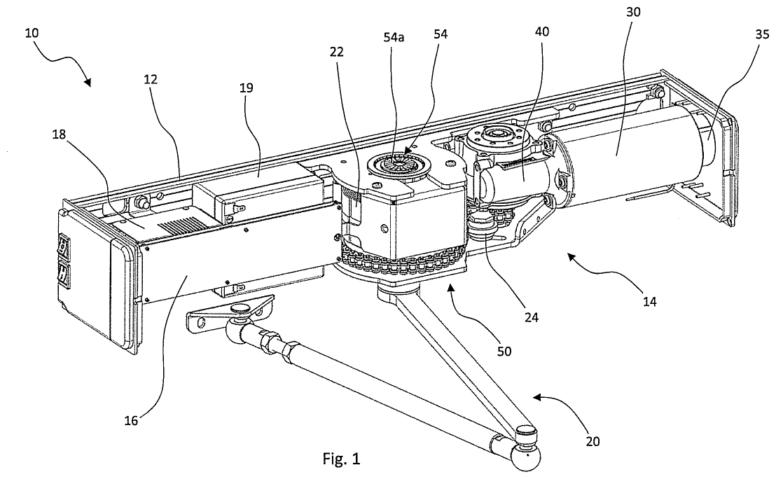

Referring to FIG. 1, an embodiment of a moving device 10 for a leaf door according to the invention is described below.

The moving device 10 includes, appropriately fixed on a frame 12, a transmission assembly 14, an electronic control unit 16 and a power supply unit 18. The electronic control unit 16, connected, for example, to special sensors (not shown) adapted to detect the presence of an individual near the door (not shown), controls the transmission assembly 14, which is configured to move an articulated arm 20 hinged to a leaf of the leaf door for opening or closing the same.

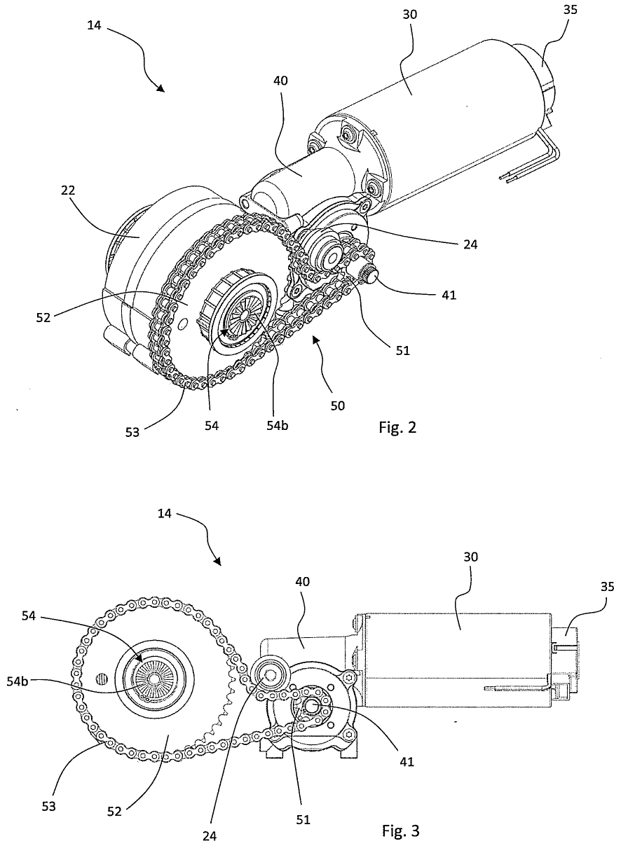

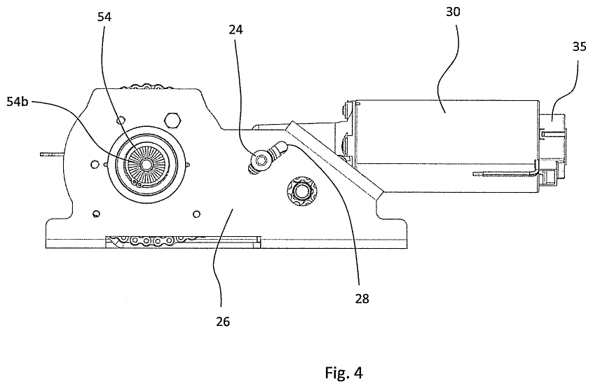

Referring in particular to FIGS. 2 and 3, the transmission assembly 14 comprises an electric motor 30, a reduction gear box (reduction gear) 40 and a crown wheel-pinion transmission system 50.

The electric motor 30, controlled by the electronic control unit 16, is kinematically connected to the reduction gear box 40. The reduction gear box 40, of known type, is preferably a reduction gear box of worm-screw type, comprising a worm screw (not shown), kinematically connected in a rotationally fixed manner to the motor shaft (not shown), and a helical toothed wheel (not shown) coupled to the worm screw, said helical toothed wheel having a rotation axis perpendicular to the rotation axis of the worm screw and being kinematically connected in a rotationally fixed manner, for example by spline-coupling, to an output shaft 41 of the reduction gear box 40.

Therefore, the reduction gear box 40 makes it possible motion transmission between two crossed shafts, namely the motor shaft and the output shaft 41 of the reduction gear box 40. In addition, the reduction gear box 40 allows to reduce the rotational speed (angular speed) from the motor shaft to the output shaft of the reduction gear box, introducing a reduction ratio R′ defined as the ratio between the rotational speed ω1 of the motor shaft and the rotational speed ω2 of the output shaft 41 of the reduction gear box 40. In particular, said reduction ratio R′ is given by the known relation R′=ω1/ω2=z/f, where z is the number of the teeth of the helical toothed wheel and f is the number of starts of the worm screw, i.e. the number of helices running over the screw.

According to the present invention, the reduction ratio R′ of the reduction gear box 40 is preferably 10:1 to 20:1, more preferably 15:1. Said reduction ratio R′ makes it possible to attain a sufficiently large reduction and to obtain, at the same time, a reduction gear box 40 of the reversible type, namely in which motion can be transmitted from the helical toothed wheel to the worm screw. The reversibility of the reduction gear box 40 is especially advantageous because it makes it possible to manually open and close the door leaf in an easy manner, without encountering too much resistance, in the event that the electric motor 30 is not energized and thus the door leaf is not opened and closed automatically.

The crown wheel-pinion transmission system 50 comprises a toothed pinion 51 and a toothed crown wheel 52 that are kinematically connected to each other by means of a roller chain 53. The pinion 51 is kinematically connected in a rotationally fixed manner, for example by spline-coupling, to the output shaft of the reduction gear box, and the toothed crown wheel 52 is kinematically connected in a rotationally fixed manner, for example by spline-coupling, to an output shaft 54 of the moving device 10, which output shaft is in turn connected in a rotationally fixed manner to the articulated arm 20 of the moving device 10.

The crown wheel-pinion transmission system 50 therefore makes it possible to transmit motion between the output shaft 41 of the reduction gear box 40 and the output shaft 54 of the moving device 10. In addition, the crown wheel-pinion transmission system 50 makes it possible to reduce the rotational speed (angular speed) from the pinion 51 to the crown wheel 52, introducing a reduction ratio R″ defined as the ratio between the rotational speed ω2 of the pinion 51, i.e. of the output shaft 41 of the reduction gear box 40, and the rotational speed ω3 of the crown wheel 52, i.e. of the output shaft 54 of the moving device 10. In particular, said reduction ratio R″ is given by the known relation R″=ω2/ω3=z3/z2 , where z2 is the number of the teeth of the pinion 51 and z3 is the number of the teeth of the crown wheel 52.

The chain 53 of the crown wheel-pinion transmission system 50 is a chain with reduced pitch, preferably between 6 mm and 8 mm. Preferably, the chain 53 is a chain provided with O-rings, of known type, i.e. a chain characterized by the presence of O-rings (not shown) located about chain pins, between external mesh plates and internal mesh plates; said O-rings make it possible to seal lubricant in the regions between pins and bushings of the chain, thus allowing a continuous or in any case more durable lubrication between pins and bushings of the chain. This avoids fast wear of these components without the need to lubricate the chain 53 from the outside, thus ensuring a longer life and therefore a greater number of open-close cycles of the device 10. An example of a chain with the above characteristics is the D.I.D ® 219V2 SDH chain.

According to another embodiment, the chain is a double chain, of known type, i.e. a chain with two rows of rollers arranged side by side. In this embodiment, too, the chain has a reduced pitch, preferably in the same range as mentioned above. In addition, in this embodiment, also the pinion and the crown wheel are double in order to be adequately coupled to the chain.

In the present invention, the use of a chain 53 with a pitch in the range shown above makes it possible to meet the requirement of having a sufficiently strong chain, while allowing use of a pinion 51 of sufficiently small size. The strength of the chain 53, indeed, decreases with the decrease of the chain pitch, whereby an excessively small pitch does not ensure a sufficient number of open-close cycles because of early break of the chain. In particular, tests carried out by the Applicant have shown that chains having a pitch in the range illustrated above are capable of performing hundreds of thousands up to more than one million (in the case of chains equipped with O-rings) of door open-close cycles before breaking. On the other hand, the size of the pinion 51 increases with the increase in the pitch of the chain 53, whereby an excessively large pitch requires use of a pinion 51 of excessive size. By using chains with pitch in the range shown above, it is possible to limit the size of the pinion 51, allowing the use of pinions with a limited number of teeth z2. In particular, according to the present invention, the number of teeth z2 of the pinion is between 8 and 14, more preferably between 8 and 9, and even more preferably is 8. This makes it possible to maintain a sufficiently high reduction ratio R″ while keeping small the number of the teeth z3 of the crown wheel 52 and therefore the size of the crown wheel itself. According to the present invention, the number of the teeth z3 of the crown wheel 52 is between 32 and 70, more preferably between 36 and 48, and even more preferably is 42. In particular, due to the high number of teeth of the pinion 51, the number of the teeth z3 of the crown wheel 52 is selected from the aforesaid values so as to obtain a reduction ratio R″ preferably not lower than 3:1. It follows from this that the reduction ratio R″ is between 3:1 and 8.75:1, more preferably between 4:1 e 6:1, and even more preferably is 5.25:1. Advantageously, the reduced size of the crown 52 makes it possible to keep the overall dimensions of the moving device 10 small, particularly in the direction orthogonal to the output shaft 54 of the moving device 10, said overall dimensions being largely dependent on the size of the crown wheel 52, the latter being the component with the largest diameter.

The overall reduction ratio R of the moving device 10 is given, as is known, by the relation R=R′×R″. The values R′ and R″ are selected from within the aforementioned ranges, so as to obtain an overall reduction ratio R preferably between 60:1 and 175:1.

Preferably, the output shaft 54 of the moving device 10 has two ends 54a, 54b, both connectable to the articulated arm 20 in such a manner as to allow the moving device 10 to be mounted even upside down, solely by changing the end of the output shaft 54 to which the articulated arm 20 is connected.

Preferably, the moving device further comprises an Archimedes spiral spring 22 (shown in FIG. 1), connected to the output shaft 54 of the moving device 10 and coiled thereabout. This spring 22 is configured to oppose the rotation of the output shaft 54 of the moving device 10 which determines the opening of the door leaf, and therefore to promote the closing of the door leaf after its opening.

Preferably, the moving device 10 further comprises a chain tensioner 24, of known type, arranged so as to ensure greater winding of the chain 53 around the pinion 51 of the crown wheel-pinion transmission system 50. Preferably, the position of said chain tensioner 24 can be adjusted by sliding the chain tensioner 24 in a corresponding slot 28 formed in a plate 26 (shown in FIG. 4) of the frame 12.

Preferably, the moving device 10 according to the invention comprises an angular position transducer or encoder 35 (shown in FIG. 1), of known type, for example an optical or magnetic encoder, applied to the electric motor 30 and capable of detecting the angular displacements of the shaft of the electric motor.

Preferably, the moving device according to the invention comprises one or more batteries 19 provided to power the electric motor 30 in case of absence of electricity from the main power supply.

According to a further preferred embodiment of the invention, the crown wheel-pinion transmission system comprises a pinion and a crown wheel that are kinematically connected to each other by means of a toothed belt.

According to a further embodiment of the invention, the crown wheel-pinion transmission system has no elements of transmission between the pinion and the crown wheel, i.e. the pinion and the crown wheel are two gears directly coupled to each other. Similarly to what has been described above, the toothed pinion is kinematically connected in a rotationally fixed manner to the output shaft 41 of the reduction gear box 40, and the toothed crown wheel is kinematically connected in a rotationally fixed manner to the output shaft 54 of the moving device. The crown wheel-pinion transmission system has a reduction ratio, defined as the ratio between the rotational speed ω2 of the output shaft 41 of the reduction gear box 40 and the rotational speed ω3 of the output shaft 54 of the moving device, between 3:1 and 10:1.

Said transmission system introduces a reduction ratio, defined, similarly to what has been described above, as the ratio between the rotational speed of the output shaft 41 of the reduction gear box 40 and the rotational speed ω3 of the output shaft 54 of the moving device, preferably between 60:1 and 200:1. The values (described above) of the reduction ratio R′ of the reduction gear box 40 and of the reduction ratio of the crown wheel-pinion transmission system with pinion and crown wheel directly coupled to each other are selected from within the respective ranges so as to obtain an overall reduction ratio preferably between 60:1 and 200:1.

The device for moving a leaf door as described and illustrated is susceptible to numerous changes and modifications falling within the same inventive principle.

1. A device for moving a leaf door, consisting of an electric motor (30), a reduction gear box (40) and a crown wheel-pinion transmission system (50), wherein the electric motor (30) is kinematically connected to the reduction gear box (40), which in turn is kinematically connected to the crown wheel-pinion transmission system (50), characterized in that the reduction gear box (40) is reversible,
wherein the reduction gear box (40) comprises a worm screw and a helical toothed wheel, wherein the worm screw is kinematically connected in a rotationally fixed manner to a shaft of the electric motor, the helical toothed wheel is coupled to the worm screw and is kinematically connected in a rotationally fixed manner to an output shaft (41) of the reduction gear box (40),
wherein the crown wheel-pinion transmission system (50) comprises a toothed pinion (51) and a toothed crown wheel (52) that are kinematically connected to each other by means of a roller chain (53), wherein the toothed pinion (51) is kinematically connected in a rotationally fixed manner to the output shaft (41) of the reduction gear box (40), and the toothed crown wheel (52) is kinematically connected in a rotationally fixed manner to an output shaft (54) of the moving device (10),
wherein the reduction gear box (40) has a reduction ratio R′, defined as the ratio between the rotational speed ω1 of the motor shaft and the rotational speed ω2 of the output shaft (41) of the reduction gear box (40), between 10:1 and 20:1 and is reversible,
wherein the crown wheel-pinion transmission system (50) has a reduction ratio R″, defined as the ratio between the rotational speed ω2 of the output shaft (41) of the reduction gear box (40) and the rotational speed ω3 of the output shaft (54) of the moving device (10), between 4:1 and 6:1, and
wherein the chain (53) of the crown wheel-pinion transmission system (50) has a pitch between 6 mm and 8 mm and the toothed pinion (51) has a number of teeth (z2) equal to 8.

2-5. (canceled)

6. A device according to claim 1, wherein the chain (53) of the crown wheel-pinion transmission system (50) comprises O-rings located about chain pins and arranged to seal lubricant in the regions between pins and bushings of the chain.

7. A device according to claim 1, wherein the chain of the crown wheel-pinion transmission system (50) is a double chain.

8. A device according to claim 1, wherein the reduction ratio R′ of the reduction gear box (40) and the reduction ratio R″ of the crown wheel-pinion transmission system (50) are chosen so as to have an overall reduction ratio R of the moving device (10) between 60:1 and 175:1.

9-10. (canceled)
